(19) United States
(12) Patent Application Publication
(10) Pub. No.: US 2004/0262422 A1
(43) Pub. Date: Dec. 30, 2004

(54) Water-activating shower apparatus

(75) Inventor: Toukichi Ichige, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: SAISEIKO CO., LTD.

(21) Appl. No.: 10/663,734

(22) Filed: Sep. 17, 2003

(30) Foreign Application Priority Data
Jun. 27, 2003 (JP) 2003-185741
Jun. 30, 2003 (JP) 2003-3909-U

(51) Int. Cl. B05B 12/08

(52) U.S. Cl. 239/63; 239/390

(57) ABSTRACT

There is provided a water-activating shower apparatus that emits activated hot or cold water without requiring a separate particular space where water is to be activated. An activated-water generating part filled with a large number of ceramic materials that radiate far-infrared rays is attached to the showerhead and/or to a pipe-connecting part upstream thereof. This water-activating shower apparatus activates the hot or cold water by far-infrared rays before the hot or cold water is emitted from the showerhead. The activated-water generating part is constituted (a) in an accommodation chamber that is formed in the showerhead, or (b) in an attachment member for attaching the showerhead.

### FIELD OF THE INVENTION

The present invention relates to a shower apparatus that activates hot or cold water and emits it without requiring a separate particular space where water is to be activated.

### BACKGROUND OF THE INVENTION

A normal showerhead that is used when taking a shower is equipped with a lever or a push button so as to control the volume and strength of hot or cold water to be emitted. In addition, in order to remove chlorine from tap water, some showerheads are constituted so that a chlorine-removing material is stored in the showerhead.

Japanese Patent Application Publication No. 2001-173050 discloses a stationary-type water-purifying/activating apparatus for purifying and activating the tap water that is to be emitted from a showerhead or used for bathwater, for example, in a home. The apparatus is equipped with a bathtub-water supply port that is connected to a water-supply pipe, a shower water-supply port that is connected to a water-supply hose, and a water-filling port that is connected via a water-filling hose; the water-supply hose and the water-filling hose are held by a locking piece that is arranged on a wall of a bathing room. A water-purifying cartridge or a water-activating cartridge is provided inside this water-purifying/activating apparatus. The water-purifying cartridge is filled with a filtering material such as activated carbon, so that it can perform the function of filtering raw tap water that is introduced into the water-purifying/activating apparatus body so that the following will be removed from the tap water: (i) abnormal odor, (ii) hazardous substances, such as residual chlorine and trihalomethane, and (iii) foreign substances, such as iron rust, rubber chips, fine grains of sand, and pieces of metal. Also, the water-activating cartridge is filled with mineral fragments, and one of its functions is to dissolve minerals that are in the raw tap water that is introduced in the water-purifying/activating apparatus body.

As a device for activating tap water, Japanese Patent Application Publication No. H11-147089 describes a pair of half cases that are installed so that they nip a tap-water pipe, and it further discloses a water-activating device wherein a line-of-magnetic force/far-infrared-ray emitting element—which is obtained by integrating a far-infrared-ray emitting element into the surface of a permanent magnet—is arranged inside at least one of the two half cases in a manner so that said element is kept parallel to the water pipe and so that said element faces the water pipe. This device can simultaneously and parallelly activate the following: (i) a line of magnetic force from magnets, and (ii) an electric field of a far-infrared ray that is emitted from the far-infrared-ray emitting element—onto the water in the water pipe. As a result, the water, such as tap water, that is flowing in the water pipe is activated, as a result of which the solubility, evaporability, deodorizing ability, antibacterial force, and other qualities of the water are enhanced.

Also, Japanese Patent Application Publication No. 2002-1317 discloses a far-infrared-ray water-purifying apparatus that can produce a large amount of activated water inexpensively. This apparatus is constituted so that a plurality of shelves filled with a far-infrared-ray radiation substance are arranged vertically at certain intervals, and so that the water in the upper shelves overflows down to the lower shelves and is retained in a water-storage tank. However, heretofore no device has been constituted so that even if a separate particular space where water is to be activated is not provided, the activated hot or cold water can be emitted from a showerhead.

### SUMMARY OF THE INVENTION

One object of the present invention is to provide a water-activating shower apparatus for emitting activated hot or cold water without requiring a separate particular space where water is to be activated.

In a shower apparatus that is constituted so that hot or cold water supplied from a hot- or cold-water supply part that is connected to a pipe for emitting the water, the present invention described in claim 1 is characterized such that an activated-water generating part filled with a large number of ceramic materials that radiate far-infrared rays is installed on a showerhead and/or a pipe-connecting part upstream of the showerhead, and that the hot or cold water is activated by the far-infrared rays before the hot or cold water is emitted from the showerhead.

According to the present invention described in claim 2, the activated-water generating part is constituted as an accommodation chamber formed in the showerhead.

According to the present invention described in claim 3, the activated-water generating part is constituted in an attachment member for attaching the showerhead at the pipe-connecting part.

The present invention described in claim 4 is characterized such that (1) the showerhead comprises (i) a main body having an accommodation chamber, (ii) a shower-generating head on the top-front edge of the main body, and (iii) a cartridge built in the accommodation chamber, and (2) the cartridge, which is filled with ceramic materials, is detachable.

The present invention described in claim 5 is characterized such that (1) the attachment member comprises (i) a water-introduction pipe that is formed so as to be attached to the pipe, (ii) a water-supply pipe that is formed so as to be attached to the showerhead, and (iii) an accommodation chamber installed between the water-introduction pipe and the water-supply pipe, and (2) the accommodation chamber is provided with (iv) connecting portions that are formed connectably by using male and female screws, and (v) a net-like part having nets that prevent the outflow of the ceramic materials.

According to the prevent invention described in claim 6, the accommodation chamber is formed of a transparent member and is cut so as to have facets like a diamond.

With regard to the hot or cold water that is emitted from the water-emission face of the shower-generating head, the present invention described in claim 7 is characterized such that (1) the water-emission condition includes a spray condition, (2) the water-emission volume can be adjusted among multiple levels, and that (3) a means for making said adjustments is installed on the outside of the water-emission face.

According to a water-activating shower apparatus of the present invention, ceramic materials that radiate far-infrared rays are stored inside a showerhead and/or an attachment member of the showerhead, and hot or cold water is brought into contact with said ceramic materials, so that the hot or cold water that is emitted is activated water. Therefore, there is no need of a separate particular space where water is to be activated.

Because a shower of water (hot or cold water emitted from a showerhead) is emitted from the above-mentioned water-activating shower apparatus, negative ions are generated, a surface-active effect is achieved, and the water has an antibacterial effect —all of which are beneficial for the health of human bodies.

The showerhead is constituted so that a cartridge can be freely inserted and removed, so that the cartridge can be replaced.

The shower-generating head is constituted so as to emit hot or cold water in a spray condition, so that the ability to emit negative ions is improved.

Because the attachment member is constituted so that connecting portions are provided for storing ceramic materials, even when a normal showerhead is attached to the attachment member, activated water can be emitted. The attachment member is formed of a transparent member and is cut so that it has facets like a diamond, and therefore the attachment member of the showerhead can have a superior design.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a view showing the assembly of the showerhead of Example 1;

FIG. 2 is a view showing the inside structure of the showerhead;

FIG. 3 is a graph comparing the spectrum data for tap water and activated water;

FIG. 4 shows the showerhead of Example 2; FIG. 4A is a plan view, and FIG. 4B is a front view;

FIG. 5 shows a tool for attaching a showerhead; FIG. 5A is a view showing how the attachment piece, and FIG. 5B is a view showing the attachment piece when in use;

FIG. 6 shows the shower head of Example 3; FIG. 6A is a view showing the assembly of the shower head; FIG. 6B is a side view, and FIG. 6C is a front view;

FIG. 7 shows a shower head wherein an operation lever is installed on the outside of the head; FIG. 7A is a plan view, and FIG. 7B is a side view;

FIG. 8 shows a different type of shower head wherein an operation lever is installed on the outside of the head; FIG. 8A is a plan view, and FIG. 8B is a side view;

FIG. 9 is a view showing how the assembly of the attachment member;

FIG. 10 is a view showing the attachment member when in use;

FIG. 11 is a view showing the attachment member when in use in a different way.

FIG. 12 shows an accommodation chamber of the attachment, with said accommodation chamber made of a transparent member and cut so as to have facets, like a diamond;

FIG. 12A shows the accommodation chamber in a condition of being separated into two parts; and

FIG. 12B shows the accommodation chamber when the two parts are connected together.

Explanation of Numbers in the Drawings

1 main body

2 shower-generating head

2a water-releasing face

2b water-releasing nozzles

2c, 2d water-releasing holes

3 cartridges

4a, 29 water-activating ceramic materials

4b chlorine-reducing particles

5 connecting portion

6 elastic member

7 engagement part

8 seal packing

9, 33 threaded parts

10 showerhead

12 attachment piece

12a spherical part of attachment piece

12b holes

12c female-screw part of attachment piece

13 ring

14 operation lever

14a operation rotary lever

20 attachment member

21 water-introduction pipe

22 accommodation chamber

23 water-supply pipe

24, 24a net-like parts

26 connecting portion

31 water-introducing port

32, 33 attachment parts

40 side wall

A enlarged portion

B spectrum of tap water

C spectrum of activated water

D hot or cold water (passage)

### DETAILED DESCRIPTION OF THE PREFERRED EMBODIMENTS

The inside of the showerhead is filled with far-infrared-ray-radiating ceramic materials, so that activated hot or cold water is emitted from the showerhead.

### EXAMPLE 1

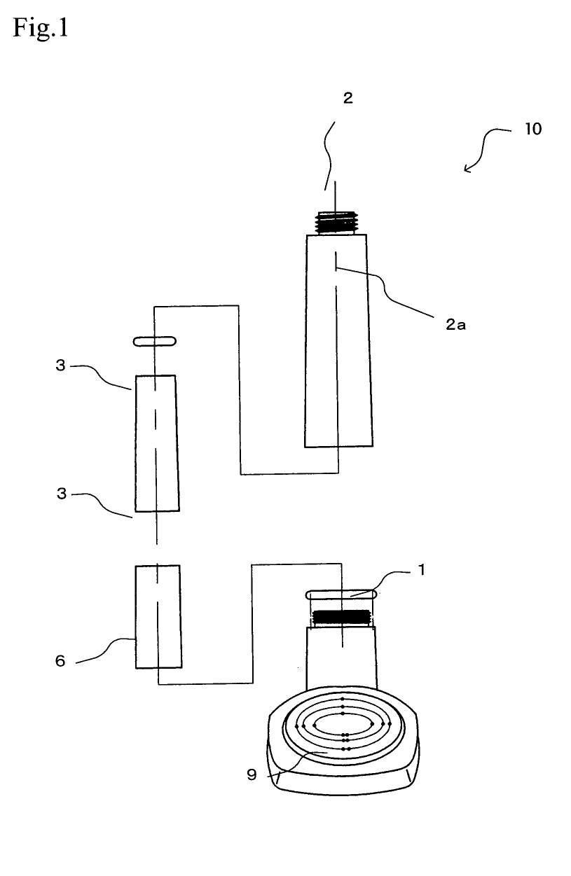

FIG. 1 is a view showing the assembly of a showerhead 10 (a water-activating shower apparatus) that is attached to the top-front edge of a tap-water (including well water) pipe (a hot- or cold-water supply part) via a hose (not shown).

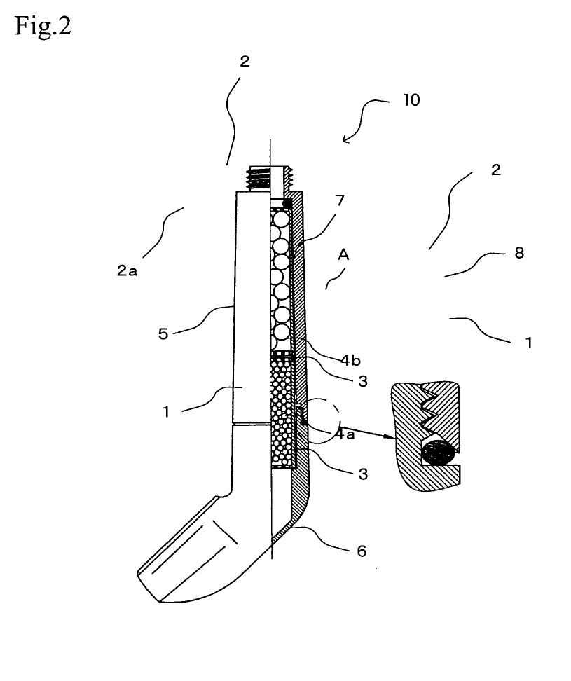

FIG. 2 shows the assembled showerhead 10, including a cross-section view of the part from the center to the right side of the assembled showerhead 10, so as to show the internal structure of the showerhead. The smaller drawing on the right side of FIG. 2 is an enlargement of the portion of the assembled showerhead 10 shown by the circle A on the main drawing.

As shown in FIGS. 1 and 2, the exterior of the showerhead 10 of the present invention consists of (1) a main body 1 that is formed so that it can be gripped with one's hands, (2) a shower-generating head 2 that is formed so that the water-emission face 2a is slightly inclined toward the main body 1, and (3) a threaded part 9 that is installed at the base end of the main body 1, and so that the inside (an accommodation chamber) of the main body 1 and the shower-generating head 2 are equipped with (a) a cartridge 3 that stores water-activating ceramic materials 4a as an activated-water-generating part, and (b) a cartridge 3 that stores chlorine reducing particles 4b. The connection portion 5 of the main body 1 and the shower-generating head 2 are formed connectably with male and female screws, and a seal packing 8 is mounted onto the connecting portion.

The front and rear portions (a water-introducing port and a tap-water outgoing port) of the cartridge 3 are formed like a net, and the cartridge 3 is nipped between (i) an elastic member 6 that is installed on the base end of the main body 1, and (ii) an engagement part 7 that is installed onto the shower-generating head 2 and fastened to the connecting portion 5. Also, the members of the main body 1, the shower-generating head 2, and the cartridges 3 are all formed of transparent synthetic resin so that the inside of those members can be seen. In addition, the cartridge 3 on the base end of the main body 1 is filled with water-activating ceramic materials 4a that emit far-infrared rays so as to reduce the size of clusters of water molecules, and the cartridge 3 on the top-front edge of the main body 1 is filled with chlorine-reducing particles 4b that reduce any residual chlorine contained in tap water. Thereby, in a process by which the hot or cold water that is supplied via a hose reaches the shower-generating head 2 from the main body 1, the water passes through the cartridge 3 and is activated by the water-activating ceramic materials 4a that are stored inside the cartridge 3.

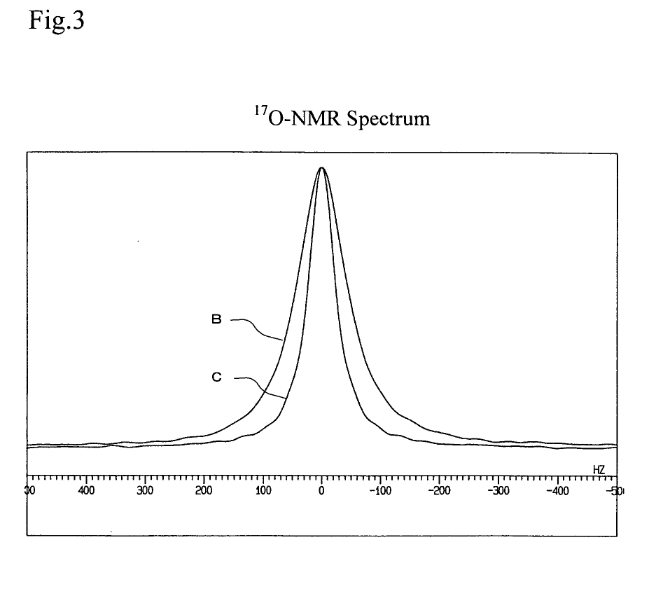

FIG. 3 shows that the tap water is activated because tap water emitted from the showerhead 10 is brought into contact with the water-activating ceramic materials 4a. This is confirmed by comparing the tap water and the activated water (the water activated by contact with the water-activating ceramic materials 4a) and using the ¹⁷O-NMR method (a magnetic-resonance method of imaging the atomic nucleus of oxygen) to measure the sizes of the groups of water molecules. The results show that the width (cluster) of the ¹⁷O-NMR line for tap water is 100 Hz (shown by line B in FIG. 3), and that the width of the ¹⁷O-NMR line for the activated water is 55 Hz (shown by a line C in FIG. 3). In this manner, the sizes of the clusters of the water molecules can be reduced by the water-activating ceramic materials 4a.

The water-activating ceramic materials 4a used in this example are preferably selected from inorganic materials such as SiO₂, Al₂₀₃, Fe₂O₃, TiO₂, CaO, K₂O, Na₂O, MgO, and MnO₂, and sintered and formed into a ball. Utilizing the water-activating ceramic materials 4a, tap water is activated by reducing the sizes of the clusters of water and by changing the water into negative-ion water. In order to confirm the effects of the activated water, the concentration of negative ions was measured when the water from the showerhead 10 was emitted for 10 seconds at a flow rate of 3.7 L/min. As a result, the maximum measured concentration was 10,130/cc, and the average of the peak values was 9,580/cc. This shows that water that is activated by reducing the sizes of the clusters of water molecules has an increased concentration of negative ions. It is known that an increase in the concentration of negative ions stabilizes the autonomic nervous system, so that it has positive influences—such as relaxing bodies, heightening immunity, and heightening natural healing energy—for maintaining the good health of human bodies. In this sense, it is understood that negative ions are good for health.

In addition, the water-activating ceramic materials 4a improve the surface-active effect of the water emitted from the showerhead. In this experiment, a 2% volume of cooking oil (triglyceride of olein acids) was added to each sample of water and was then agitated for 1 minute. After 5 minutes had elapsed after the agitation, ¹H-NMR spectrums (by magnetic-resonance imaging of atomic nucleus of hydrogen) were measured, and the volume of the cooking oil dissolved in each sample water was calculated. The results showed that the volume of the cooking oil dissolved in normal tap water was 6.57 mMol, while it was 13.47 mMol in the activated water. It was thus confirmed that the activated water dissolved about twice the volume of cooking oil than the normal tap water did. In this way, because the activated water improves the surface-active effect of the water emitted from the showerhead, tap water can be improved so that it infiltrates skin well, so that skin can be washed well and dirt can be removed efficiently, so that a beautifying effect on skin can be achieved. In addition to the above-mentioned purifying ability that is improved by the activated water, the activated water also has antibacterial action, which is effective in helping to keep a bathing room clean. The antibacterial test showed that the water activated by the water-activating ceramic materials 4a had an antibacterial effect against bacillus coli and staphylococcus aureus, and had such an effect that all the bacteria were killed within 24 hours.

### EXAMPLE 2

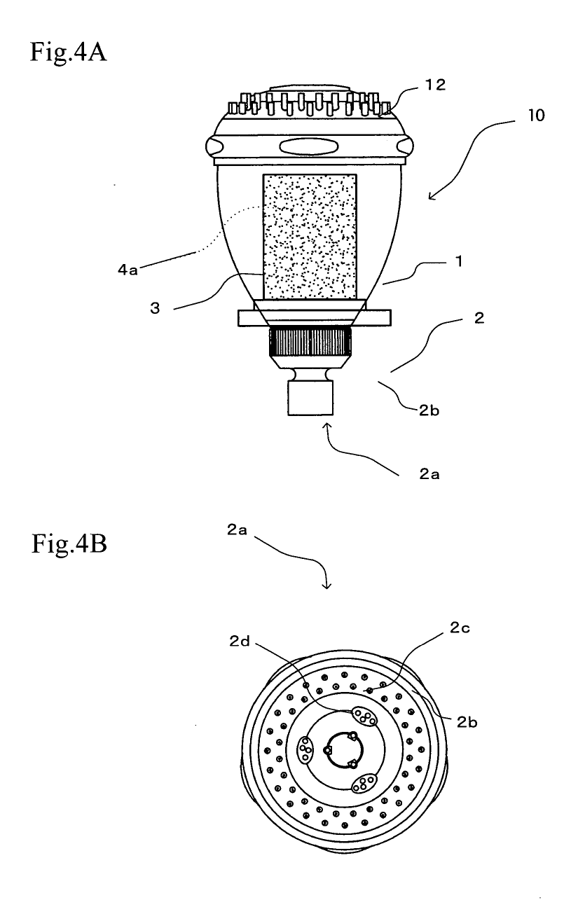

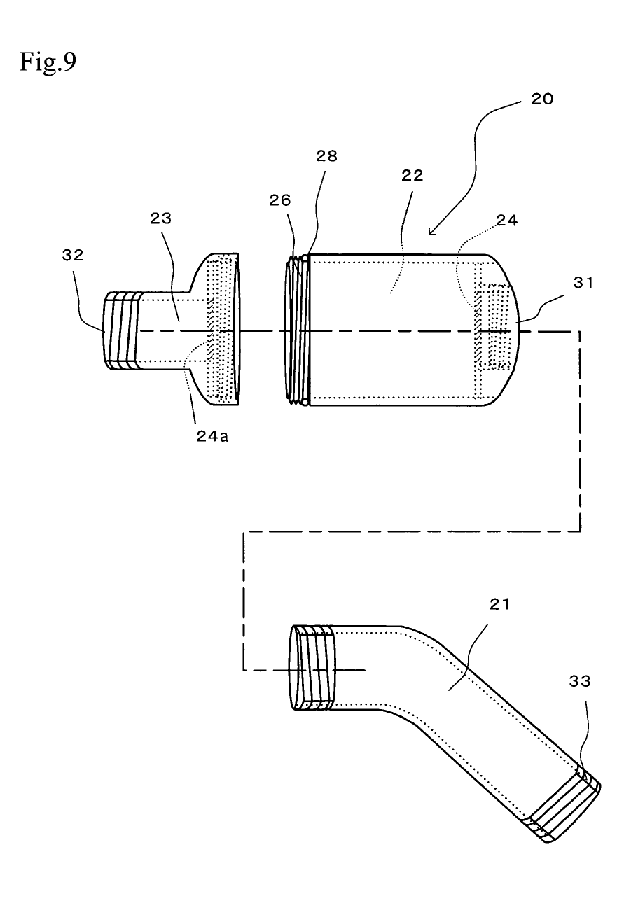

FIG. 4 shows the showerhead 10 (a water-activating shower apparatus) of Example 2, connected to a hot- or cold-water supply part via an attachment member 20 (see FIGS. 9-12); FIG. 4A is a plan view, and FIG. 4B is a front view of the showerhead. As shown in FIGS. 4A and 4B, in the showerhead 10, at least the cartridge 3, which is filled with water-activating ceramic materials 4a, is installed in the main body 1, and protruding rubber water-emitting nozzles 2b, and water-emitting holes 2c and 2d, which are connected to the main body so as to pass hot or cold water therethrough, are installed on the water-emission face 2a of the showerhead 10. Thereby, as is similar to Example 1, the hot or cold water is activated by the water-activating ceramic materials 4a and is then emitted from the showerhead.

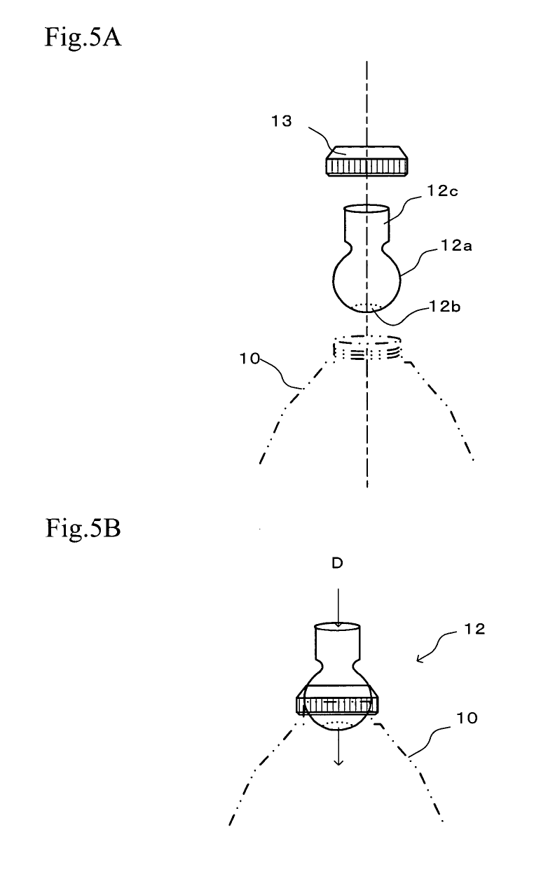

FIG. 5 shows an attachment piece 12 (connection means) for attaching the showerhead 1 of FIG. 4. FIG. 5A shows how the attachment is effected, and FIG. 5B shows the condition when the attachment piece is attached to the main body 1. As shown in FIGS. 5A and 5B, in the attachment piece 12, the spherical part of the attachment piece 12a, which has a hole 12b for passing the hot or cold water, includes a female-screw part 12c of the attachment piece 12 that is screwed to the attachment member 20 (see FIGS. 9-12). A part of the spherical body 12a is inserted into a water-introducing port on the side of the main body 1, and the attachment piece 12 is fastened between the attachment member 20 and the showerhead 10 by a ring 13, and is attached to the showerhead. Thereby, the attachment piece 12 feeds the hot or cold water (shown by arrow D in FIG. 5) from the hot- or cold-water supply part to the shower-generating head 2, and also enables a user to freely change the inclination angle of the showerhead 10 with his/her hands.

### EXAMPLE 3

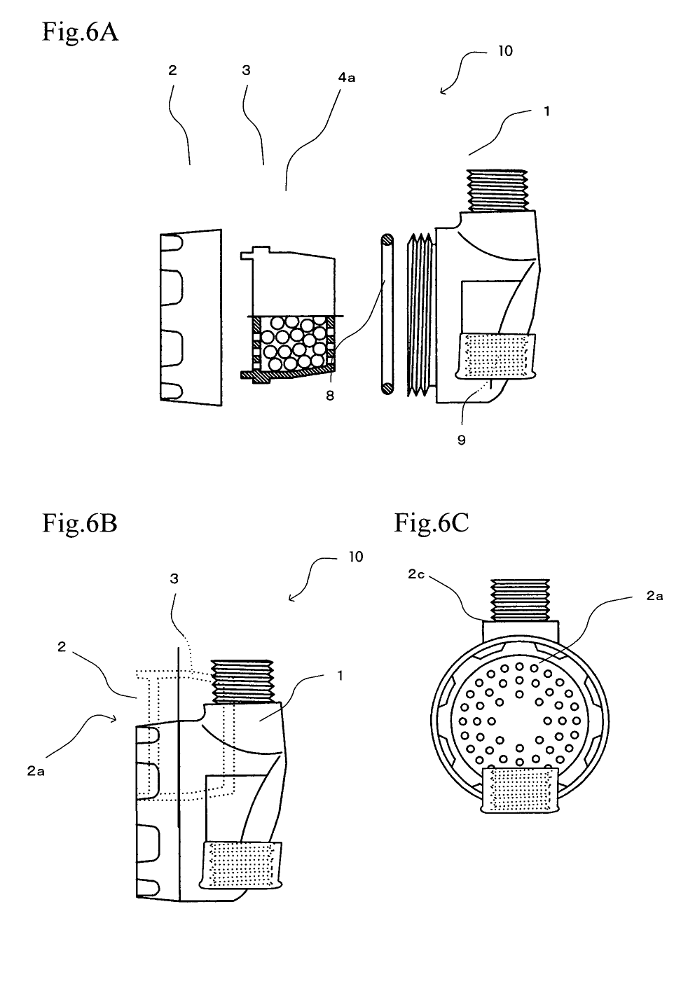

FIG. 6 shows the showerhead 10 (the water-activating shower apparatus) of Example 3, connected to the hot- or cold-water supply part via the attachment member 20 (see FIGS. 9-12); FIG. 6A is a view showing the assembly of the showerhead 10; and FIG. 6B and FIG. 6C are a side view and front view, respectively, of the showerhead. In this showerhead 10 of Example 3, the shower-generating head 2 is formed as a cap that covers the cartridge 3 that stores the water-activating ceramic materials 4a, and the cartridge 3 is attached so as to protrude from the main body 1. The showerhead 10 is thereby constituted so that the water is emitted as if it were emitted directly from the cartridge 3 installed in the main body 1. That is to say, the shower-generating head 2 that covers the cartridge 3 is screwed into the main body 1 so as to form the water-emission face 2a, while the gap between the shower-generating head 2 and the cartridge 3 is narrowed as much as possible, so that activated hot or cold water can be emitted.

### EXAMPLE 4

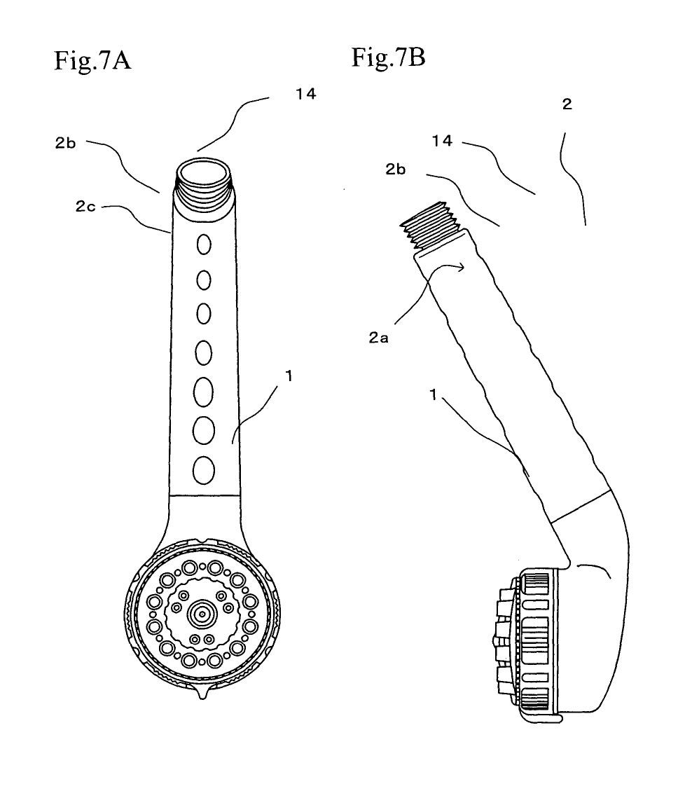

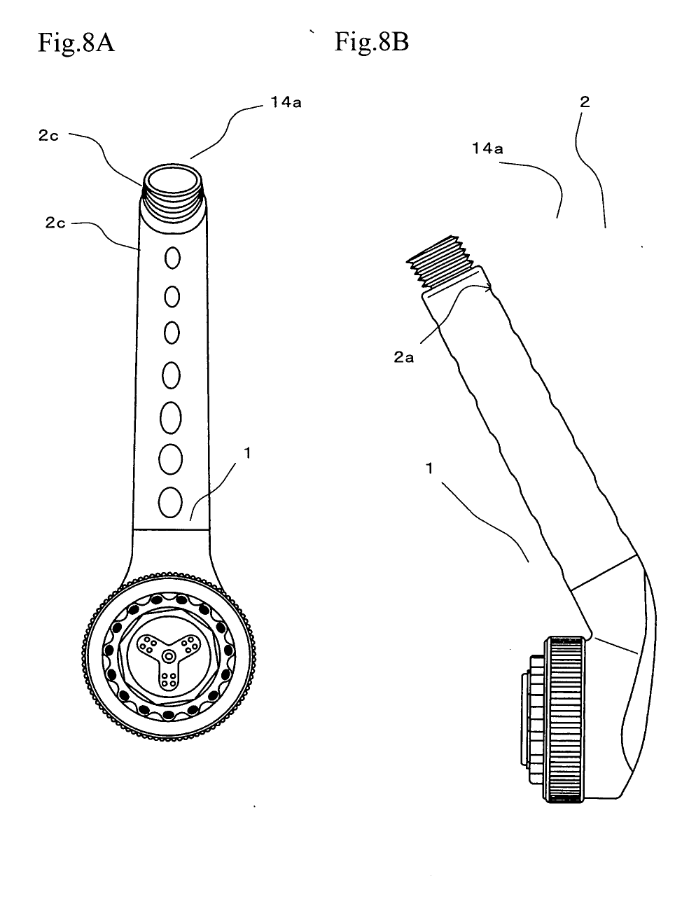

FIGS. 7 and 8 show the showerhead 10 that is connected to the hot- or cold-water supply part via a hose; FIGS. 7A and 8A are plan views, and FIGS. 7B and 8B are side views. In the showerhead 10 in Example 4, an operation lever 14 or an operation rotary lever 14a is installed on the outside of the shower-generating head 2, and the operation lever 14 or the operation rotary lever 14a is operated so as to adjust in a multistage manner the volume of hot or cold water that is emitted.

By such an operation of the operation lever 14 or the operation rotary lever 14a, the condition of the water being emitted from the water-emission face can be switched from a condition of emitting the water in the form of thin lines from a plurality of the water-emitting nozzles 2b and the water-releasing holes 2c to a condition of emitting the water in the form of a mist. When the water is to be emitted in the form of thin lines, nets are made to cover the bases of the water-emitting nozzles 2b and the water-releasing holes 2c, and the water passes through the nets. In contrast, when the water is to be emitted in the form of a mist, spray nozzles are attached to the water-releasing nozzles 2b or the water-releasing holes 2c, so that fine particles of water are emitted. For the spray nozzle, a type that rotates and sprays the particles of water is used, so that the hot or cold water can be made into particles as fine as possible. In this manner, when the hot or cold water to be emitted is made into particles as fine as possible, the ability of radiating negative ions so as to generate negative ions in the air is improved, which is beneficial for human health. In addition, because water-activating ceramic materials that activate molecules of water with far-infrared rays are stored inside the showerhead 10, the effect of generating a large amount of negative ions in the air is increased further.

### EXAMPLE 5

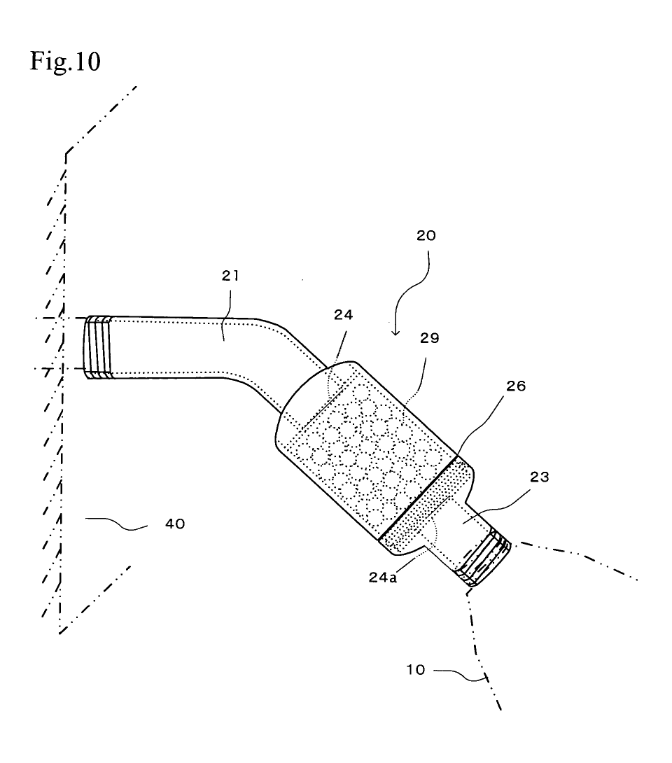

FIG. 9 is a view showing the assembly of an attachment member 20 in a water-activating shower apparatus, and FIG. 10 is a view showing the attachment member 20 (the water-activating shower apparatus) when it is in use. The attachment member 20 is used for attaching the showerhead 10, and it comprises (i) a water-introduction pipe 21, to which a threaded part 33 is formed so as to attach the water-introduction pipe 21 to the top-front edge of the pipe of the hot- or cold-water supply part, (ii) a water-supply pipe 23, to which a threaded part 32 is formed so as to attach the water-supply pipe 23 to the showerhead 10, and (iii) an accommodation chamber 22 (an activated-water generating part) that is formed between the water-introduction pipe 21 and the water-supply pipe 23 and that has a storage space for storing water-activating ceramic materials 29.

The accommodation chamber 22 is formed so as to be separable into two portions having a connecting portion 26 that is formed connectably by using male and female screws, and one of the two separated parts is connected to the water-supply pipe 23. The accommodation chamber 22 is equipped—on its right and left sides—with (i) a net-like part 24, which is formed on the side of the water-introducing port 31, and (ii) a net-like part 24a, which is formed on the side of the hot or cold water-supply pipe 23, and the accommodation chamber 22 stores the water-activating ceramic materials 29 that radiate far-infrared rays.

The water-introduction pipe 21 is bent slightly downwards. Thus, when the water-introduction pipe 21 is attached to the accommodation chamber 22 with screws, the accommodation chamber 22 and the water-supply pipe 23 are attached to the top-front edge of the pipe of the hot- or cold-water supply part, under the condition that the accommodation chamber 22 and the water-supply pipe 23 slant towards the front.

That is to say, as shown in FIG. 10, the water-introduction pipe 21 of the attachment member 20 is usually attached to the top-front edge of the pipe of the hot- or cold-water supply part that is screwed to a side wall 40 of a bathing room or the like, and the showerhead 10 is attached to the tip of the water-supply pipe 23. The water-activating ceramic materials 29 are stored in the accommodation chamber 22, and thereby the attachment member 20 activates the hot or cold water supplied from the hot- or cold-water supply part and supplies it to the showerhead 10.

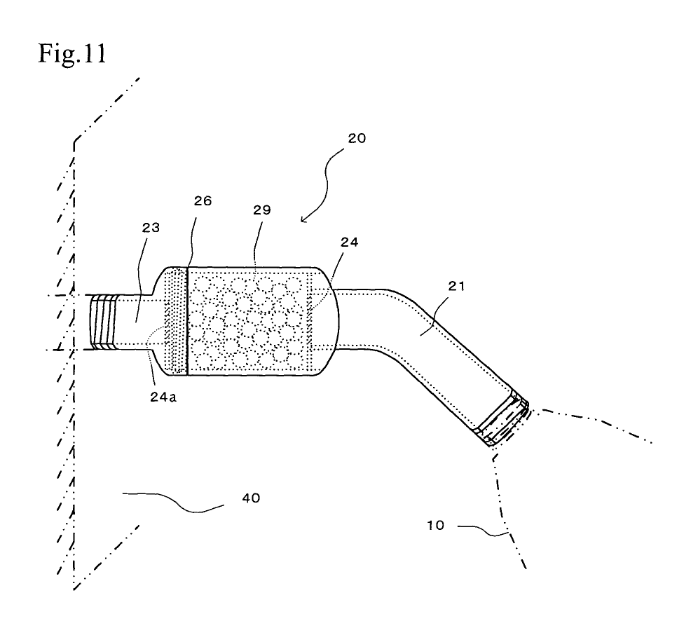

In FIG. 11, the water-supply pipe 23 (the water-introduction pipe) is attached to the top-front edge of the pipe of the hot- or cold-water supply part that is attached to the side wall 40 of a bathing room or the like, and the showerhead 10 is attached to the water-introduction pipe 21 (the water-supply pipe). In this manner, the attachment member 20 can be attached in a direction opposite to that of FIG. 10. Also, the direction for emitting water from the showerhead 10 is determined by using one's hands to adjust the base of the showerhead 10.

### EXAMPLE 6

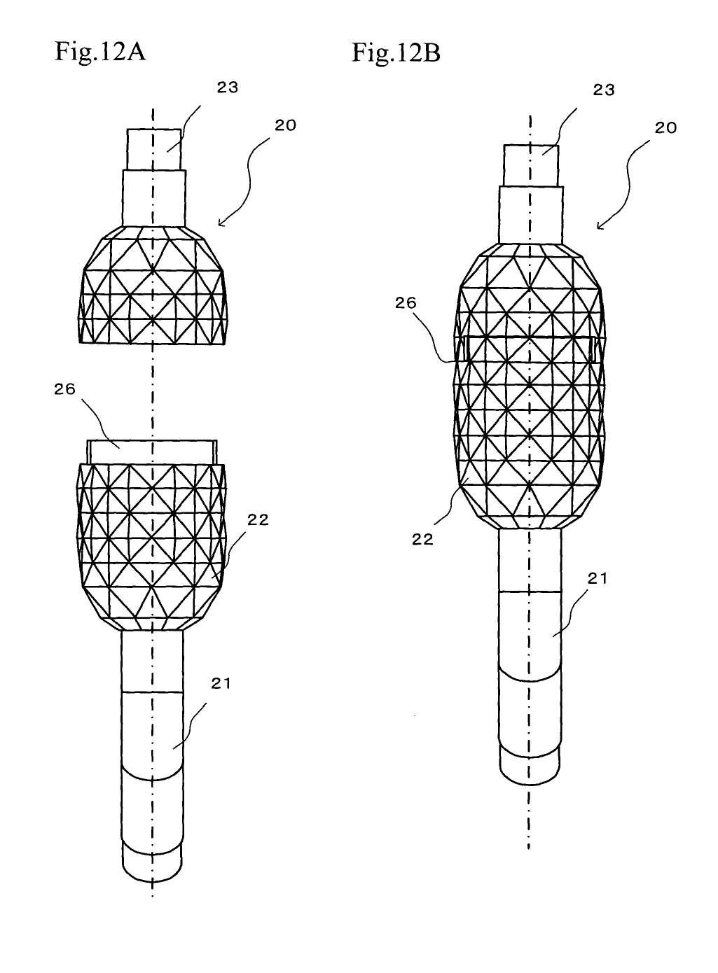

FIG. 12 shows the condition when the accommodation chamber 22 of the attachment member 20 is made of a transparent member and is cut so as to have facets like a diamond; FIG. 12A shows the accommodation chamber 22 in a condition of being separated in two parts, and FIG. 12B shows the two parts connected together. Because the attachment member 20 is attached to the side wall 40 of a bathing room or the like as a part of a shower facility in such a room, it is attached at a position where it can always be seen by a user. Therefore, it is formed with an emphasis on its design, as is similar to the case of the showerhead 10.

In addition, although the attachment member 20 is used for attaching the showerhead 10 in a bathing room, it can also be attached to the top-front edge of a tap-water pipe as a joint member for connecting to tap-water facilities that are provided in a room (such as the base of a faucet for obtaining drinking water, or a faucet base supplied to a dishwasher or a washing machine). When the attachment member 20 is used this way, it serves as part of a facility for supplying tap water in a restroom, a kitchen, or the like, and the activated tap water can be supplied and be used to benefit human health.

What is claimed is:

1. A water-activating shower apparatus, which is constituted to emit water by connecting hot or cold water supplied from a hot- or cold-water supply part with a pipe, and wherein an activated-water generating part that is filled with a large number of ceramic materials that radiate far-infrared rays is attached to a showerhead and/or a pipe-connecting part upstream thereof, and the hot or cold water is activated by said far-infrared rays before the hot or cold water is emitted from said showerhead.

2. A water-activating shower apparatus described in claim 1, wherein said activated-water generating part is constituted as an accommodation chamber formed in said showerhead.

3. A water-activating shower apparatus described in claim 1, wherein said activated-water generating part is connected to an attachment member for attaching said showerhead at said pipe-connecting part.

4. A water-activating shower apparatus described in claim 2, wherein said showerhead comprises a main body having said accommodation chamber and a shower-generating head on the top-front edge of said main body, and with said cartridge being filled with said ceramic materials and structured so as to be detachable.

5. A water-activating shower apparatus described in claim 3, wherein said attachment member comprises (i) a water-introduction pipe that is formed so as to be attached to said pipe, (ii) a water-supply pipe that is formed so as to be attached to said showerhead, and (iii) an accommodation chamber installed between said water-introduction pipe and said water-supply pipe, with said accommodation chamber being equipped with (iv) a connecting portion formed connectably with male and female screws, and (v) a net-like part having nets for preventing the outflow of said ceramic materials.

6. A water-activating shower apparatus described in claim 5, wherein said accommodation chamber is made of a transparent member and is cut so as to have facets, like a diamond.

7. A water-activating shower apparatus described in claim 4, wherein hot or cold water emitted from the water-emission face of said shower-generating head is formed so that a water-emission condition thereof includes a spray condition, so that the water-emission volume can be adjusted in stages, and so that a means for adjusting said volume is installed on the outside of said water-emission face.
